(19) United States
(12) Patent Application Publication
(10) Pub. No.: US 2012/0106717 A1
(43) Pub. Date: May 3, 2012

(54) SYSTEM, METHOD AND APPARATUS FOR PREFERENCE PROCESSING FOR MULTIMEDIA RESOURCES IN COLOR RING BACK TONE SERVICE

(75) Inventors: Hao Dong, Shenzhen (CN); Zheng Huang, Shenzhen (CN)

(73) Assignee: ZTE Corporation, Shenzhen (CN)

(21) Appl. No.: 13/259,179

(22) PCT Filed: Mar. 24, 2010
(86) PCT No.: PCT/CN2010/071259

§ 371 Date: Dec. 30, 2011

(30) Foreign Application Priority Data
Jun. 30, 2009 (CN) 200910151547.0

(51) Int. Cl. H04M 1/64

(52) U.S. Cl. 379/70

(57) ABSTRACT

For realizing priority policy processing with complex preference in color ring-back tone service, a system for preference processing of multimedia resources in color ring-back tone service is provided by the invention, which comprises: a multimedia color ring-back tone Customized Multimedia Ringing (CMR) Server, which determines the resources which need to be presented based on a priority policy and presents the resources; and a CMR User Interface Unit, which is connected to the CMR Server. A user inquires and sets a priority policy by the CMR User Interface Unit. Moreover, a method and an apparatus for preference processing of multimedia resources in color ring-back tone service are provided by the invention. By implementing the system, method and apparatus of the invention, a user can inquire and set a priority policy corresponding to complex preference, thus the system is enabled to determine the highest priority policy under specified conditions, so as to present preference resources set by users.

### FIELD OF THE INVENTION

This invention relates to the field of mobile communication, more specifically, to a system, method and apparatus for preference processing of multimedia resources in color ring-back tone service.

### BACKGROUND OF THE INVENTION

Traditional color ring-back tone service is customized by a called party, and provides the calling party with a sweet music or a greeting to substitute the service of normal ring-back tone. With the development of the communication network and the improvement of the performance of user's terminal equipment, color ring-back tone service has been expanded. During the establishment of a point-to-point call, when a called user terminal is ringing, the calling user terminal receives an audio and/or video segment, or other multimedia resources like characters, pictures and animations preset by the called user terminal. Meanwhile, a user can set which resources to present and how to present those resources, which is called the users preference setting of color ring-back tone.

Generally, only simple information such as the calling party's number and time period information can be set in the user preference setting functions provided by the existing color ring-back tone service.

On the other hand, the combination of multimedia color ring-back tone service and other services can bring excellent users experiences. For example, presence service can provide the current online presence information of a user, including the availability of the terminal and the state set by the user himself, such as “Idle”, and “Busy”. If a calling user can acquire the presence information of the called user instead of some brief ring-back tone resources set by the called user in prior color ring-back tone service when the calling user makes a telephone call, it will present the calling user with pleasant surprise. For another example, the combination of multimedia color ring-back tone service and the location service, i.e. including location information of the called user within the ring-back tone media or playing different ring tone resources according to different locations of the called user, can also present the calling user with excellent service experience.

The new services stated above also brings a new technical requirement: how to perform the complex preference processing for multimedia color ring-back tone which a user would like to present according to the above mentioned information related to the user.

### SUMMARY OF THE INVENTION

The purpose of this invention is to realize the priority policy processing of complex preference in color ring-back tone service.

For realizing the purpose, a system for preference processing of multimedia resources in color ring-back tone service is provided by this invention, which comprises: a multimedia color ring-back tone Customized Multimedia Ringing (CMR) Server, adapted to determine the resources which need to be presented based on a priority policy and present the resources; and a CMR User Interface Unit, which is connected to the CMR Server. A user inquires and sets a priority policy by the CMR User Interface Unit.

The system also includes a Presence Server, adapted to acquire the presence information of a user and feed back the presence information to the CMR Server; and a Location Server, adapted to acquire the location information of a user and feed back the location information to the CMR Server.

In addition, for realizing the purpose, a method for preference processing of multimedia resources in color ring tone service is provided by this invention, which includes the following steps: when a user is called, acquiring related information of the user, determining the highest priority sub-policy among the one or multiple sub-policies set by the user as the priority policy, and presenting the resources corresponding to the priority policy when related information matches the condition information contained in the priority policy.

The related information comprises one or multiple of: user presence information, location information, called time information and called date information as well as ID information of the calling user.

In addition, for realizing the purpose, an apparatus for preference processing of multimedia resources in color ring-back tone service is provided by this invention, which comprises: a Related Information Acquiring Unit, adapted to acquire related information of a user when the user is called; a Sub-policy Determination Unit, adapted to determine the highest priority sub-policy among one or multiple sub-policies set by the user as the priority policy; and a Presence Unit, adapted to present resources corresponding to the priority policy when related information matches the condition information contained in the priority policy.

By implementing the system, method and apparatus of this invention, a user can inquire and set a priority policy corresponding to complex preference, thus the system can determine the highest priority policy under specified conditions, so as to present preference resources set by users.

### BRIEF DESCRIPTION OF THE DRAWINGS

The drawings illustrated herein are used to provide a further understanding of this invention, and constitute one part of this application. The exemplary embodiments of the invention and the illustrations thereof are used for explanation, and do not constitute limitations on the invention. In the Drawings:

FIG. 1 shows a block diagram of the system for preference processing of multimedia resources in color ring-back tone service according to this invention;

FIG. 2 shows a schematic diagram of the operating procedures for preference setting according to the method of this invention; and

FIG. 3 shows a flow chart of the method for preference processing of multimedia resources in color ring-back tone service according to this invention.

### DETAILED DESCRIPTION OF THE EMBODIMENTS

Hereinafter, the system, method and apparatus for preference processing of multimedia resources in color ring-back tone service will be described with reference to the drawings.

In the embodiment of this invention, the user preference setting of multimedia color ring-back tone presentation comprises a preset policy (i.e. preference rule set). This rule set comprises several sub-policies (i.e. rule sub-sets), and these rule sub-sets can be divided into two types: Simplex Rule Sub-set and Complex Rule Sub-set. Each Simplex Rule Sub-Set comprises preference rules of the same type, and each preference rule comprises several condition fields and one target field. Condition fields describe the conditions that should be satisfied by this rule, and constitute a Condition Module, while the target field describes the target results caused by this rule after the above mentioned conditions are satisfied, and constitutes a Target Module; furthermore, the conditions generated by the condition fields of any two preference rules within the same rule sub-set do not overlap with each other. A Complex Rule Sub-set comprise such rules: the condition fields of each rule comprise two or more different types of preference rule conditions, and the target field of this rule describes the target results caused by this rule after the complex conditions are satisfied. Each rule sub-set corresponds to one priority, and the priority of different rule sets differs from each other.

The following is the analysis of several Simplex Rule Sets.

Time Rule Set, wherein the conditions of each rule comprise start time and end time, and the target field indicates the presented ring tone resources or resource box ID after the conditions of this rule are satisfied. The resource box is the resource collection composed by multiple resources which can be ordered by a user at one time. The determination logic of each rule is that the time of conducting calling is precisely between the start time and end time of this rule; the actuating logic is to present the resources described by the target field after the conditions are satisfied.

Date Rule Set, wherein the conditions of each rule comprise start date and end date, and the target field indicates the presented ring tone resources or resource box ID after the conditions of this rule are satisfied. It needs to be noted that the date format in the conditions can also be a certain day in every week. The determination logic and actuating logic of the rule in this set are similar to those of Time Rule Set.

Calling ID Rule Set, wherein the condition of each rule is the number ID or number group ID of the calling user, and the target field indicates the presented ring tone resources or resource box ID after the condition of this rule is satisfied. Thus it can be determined whether the condition of the rule is satisfied according to the calling number ID when calling is conducted, and the target of this rule will be performed if the condition is satisfied.

User Presence Rule Set, wherein the condition of each rule is the acquired current presence information of the called user, and the target field indicates the presented ring tone resources or resource box ID after the condition of this rule is satisfied. The condition of this rule can comprise some specific state-describing information fields, such as “Power Off” and “Busy” etc. of the information fields of terminal equipment, and “Busy” and “At Meeting” etc. of the user state information fields of a user. Resources described by the target field can be some resource templates corresponding to the information described in the condition fields. For example, if a user is “At Meeting”, the voice prompt will be “Sony, I am at a meeting now, please contact me later . . . .”

User Location Rule Set, wherein the condition of each rule is the acquired current location information of the called user, and the target field means the presented ring tone resources or resource box ID after the condition of this rule is satisfied. With regard to the location type rules, target resources can be voice prompt acquired by transforming and combining the user's geographic location information through text.

There are also complex rules combined by the conditions of the above mentioned two or more types of rules, except the above mentioned Simple Rule Sets. For example:

Specific ring tone resources are presented under the condition that both a certain time period and a certain calling user group are satisfied simultaneously.

All the complex rules constitute Complex Rule Set of a user's preference setting.

Each rule set corresponds to one priority, and the priority of different rule sets differs from each other, which is used for performing determination logic according to order of priority when presence control is performed. Users can set the priority of each rule set.

The system according to this invention includes: a Customized Multimedia Ringing Server (CMRS), adapted to store and receive rules set by users, and meanwhile conduct resource presence control during call-connection; and a CMR Portal (CMRP) or CMR Management Client (CMRMC), adapted to be set and operated by users. It also comprises a Presence Server (PS), adapted to acquire the presence information of a user, and a Location Server (LS) adapted to acquire the geographic location information of a user.

A user inquires and sets the preference rules stored in the CMR Server by the CMR Portal or the CMR Management Client. When a call triggers the CMR, the Presence Control Module inquires the stored preference rules based on current user-related information and other information, to acquire and present corresponding target resources.

Specifically, the units in the system and their functions according to the present invention are described as follows:

Customized Multimedia Ringing Server (CMRS): the core device of the service described in the present invention, which is adapted to determine the resources which need to be presented based on a priority policy and presents the resources;

CMR User Interface Unit, which is connected to the CMR Server. A user inquires and sets a priority policy with the CMR User Interface Unit. Wherein, the CMR User Interface Unit can be a CMR Portal and the user performs inquiry and setting of the preference rules through Web/WAP; the CMR User Interface Unit can also be a CMR Management Client residing in the user terminal, and interacts with the CMR Server in the form of client, performing inquiry and setting of the preference rules;

Presence Server (PS): provides the presence information a subscribed user of the service described in the invention, for instance, On-Line, Busy and Out Of Service, etc.;

Location Server (LS): acquires the location information of a user and feeds back the location information to the CMR Server. The Location Server comprises: a Geography Server, adapted to provide the geographical location information in the form of longitude and latitude of a subscribed user of the service described in the invention; a Geographical Information System (GIS) Module, adapted to convert the longitude and latitude coordinate of that geographical area that the user terminal locates into the location information which can be understood by a user. The GIS Module can be located in LS, and then the CMR Server directly acquires the user's location information in the form of text, such as city, block, and name of the landmark building. The GIS Module can also be located in the CMR Server, and then the CMR Server acquires the longitude and latitude coordinate of a user terminal from LS, and then the GIS Module converts them into the geographic location information which can be understood by a user.

Further, a CMR Server comprises:

Storage Unit, adapted to store the preference rules set by a user;

Inquiry Unit, adapted to receive user's inquiry request, and return the rule information acquired from Rule Storage Module to the user by the CMR Portal or Management Client;

Setting Unit, adapted to receive user's setting operations, and store the setting results into Rule Storage Module;

Presence Control Unit, adapted to perform logical judgment based on the rules in the Storage Unit when a call occurs, determine the resources which need to be presented, and present the resources.

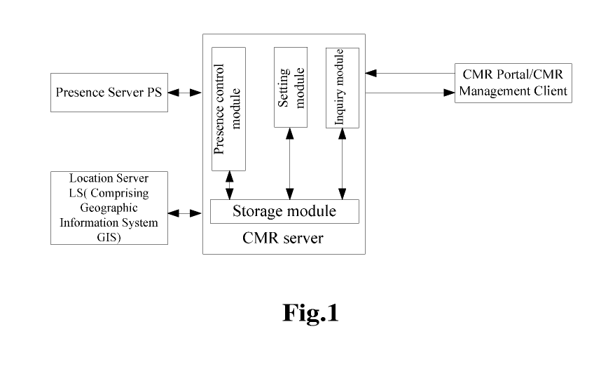

FIG. 1 is a block diagram of a system for preference processing of multimedia resources in color ring-back tone service according to this invention.

“Rules” in Rule Set is defined as follows:

Time Rule Set: every rule therein comprises the following fields:

| Field Name | Data Type | Description | Field Category |
|---|---|---|---|
| FromTime | Time | Start time | Condition |
| ToTime | Time | End time | Condition |
| ResourceID | String | Resource Identifier | Target |

Date Rule Set: every rule therein comprises the following fields:

| Field Name | Data Type | Description | Field Category |
|---|---|---|---|
| FromDate | Date | Start date | Condition |
| ToDate | Date | End date | Condition |
| ResourceID | String | Resource Identifier | Target |

Calling ID Rule Set: every rule therein comprises the following fields:

| Field Name | Data Type | Description | Field Category |
|---|---|---|---|
| CallingID | String | Calling No. or Calling | Condition |
| | | Group Identifier | |
| ResourceID | String | Resource Identifier | Target |

User Presence Rule Set: every rule therein comprises the following fields:

| Field Name | Data Type | Description | Field Category |
|---|---|---|---|
| PresenceInfo | String | User's Presence | Condition |
| | | Information | |
| ResourceID | String | Resource Identifier | Target |

User Location Rule Set: every rule therein comprises the following fields:

| Field Name | Data Type | Description | Field Category |
|---|---|---|---|
| Location | String | User's Geographical | Condition |
| | | Location Information | |
| ResourceID | String | Resource Identifier | Target |

Complex Rule Set: the condition fields included in the rules therein can be the combination of the condition fields in the simplex rules above, and the target field is the target resource ID when the complex rules are satisfied. For example, time condition and user's presence condition can be combined into the following complex rules:

| Field Name | Data Type | Description | Field Category |
|---|---|---|---|
| FromTime | Time | Start time | Condition |
| ToTime | Time | End time | Condition |
| PresenceInfo | String | User's Presence | Condition |
| | | Information | |
| ResourceID | String | Resource Identifier | Target |

The system can be set as the combination of different types of conditions based on user's requirements to obtain various complex rules, which is not repeated herein.

By setting different priorities (Data Type Integer) for every rule set above, the Presence Control Module can perform logical judgment according to the priority to acquire the resource information which should be presented.

The storage of the above rules can be in the form of Database (DB) as well as XML document.

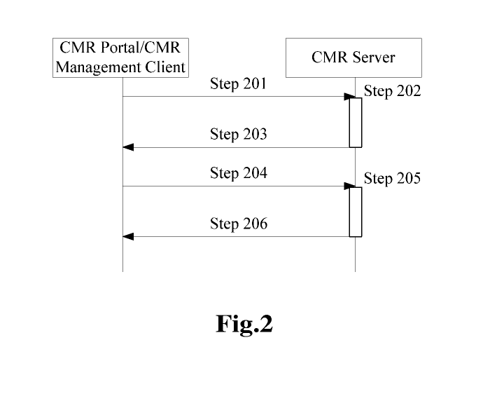

FIG. 2 shows a schematic diagram of the operating procedures for preference setting according to the method of this invention. The Steps therein are explained as follows:

Step 201: CMR Portal or CMR Management Client sends the request for inquiring preference rules to CMR Server;

Step 202: CMR Server acquires the information of preference rules from the internal Storage Module;

Step 203: CMR server returns the information of preference rules;

Step 204: CMR Portal or CMR Management Client sends the request for setting preference rules to CMR Server;

Step 205: CMR Server performs check of the setting request, and performs the operations of insertion/modification/deletion to the rules in the Storage Module if the setting request is correct;

Step 206: CMR Server returns the operation result.

The interactive protocols in the above Steps can be based on HTTP Protocol, for example, XCAP Protocol or SOAP Protocol.

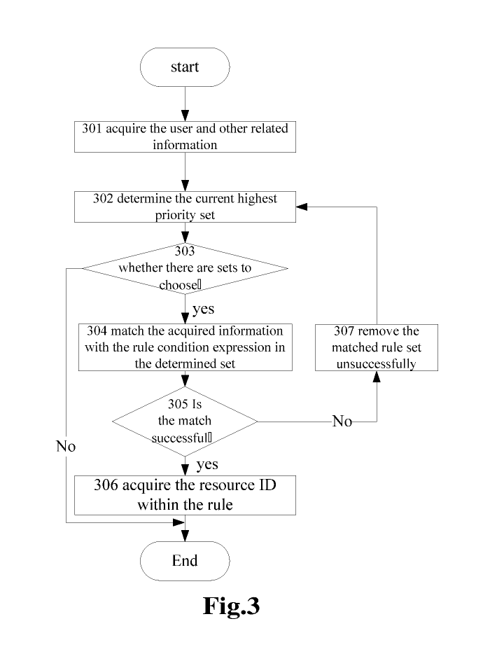

FIG. 3 is a flowchart of the logical judgment through which the Presence Control Module selects the ringing resources during the calling, after a CMR user performs the preference setting described in the present invention. The Steps are as follows:

Step 301: Acquire a user and other related information;

Step 302: Determine the current rule set with the highest priority in existing multiple preference rule sets;

Step 303: Determine whether there are rule sets to select, and if yes, execute Step 304; or else, return the message of rule match failure, or return the defaulted resource ID, and the procedure ends;

Step 304: Perform matching between the acquired information and the determined rule condition expressions in the highest priority sets;

Step 305: If the matching succeeds, execute Step 306; or else, execute Step 307;

Step 306: Acquire the target resource ID from the rules that have been matched successfully, and the procedure ends;

Step 307: Remove the rule sets that have been matched unsuccessfully, and return to Step 302.

Hereto, the Presence Control Module acquires the resource ID which needs to be presented.

The foregoing description is only preferred embodiments of the present invention, and does not constitute limitations for the present invention. As for those skilled in the art, various modifications and changes can be made for the present invention. Any modification, equivalent substitution and improvement etc. made within the spirit and principle of the present invention shall be included in the protection scope of the present invention.

1. A system for preference processing of multimedia resources in color ring-back tone service, comprising:
a customized multimedia ringing (CMR) server, adapted to determine resources which need to be presented based on a priority policy, and present the resources; and
a CMR user interface unit, which is connected to the CMR server, and by which a user inquires and sets the priority policy.

2. The system according to claim 1, wherein the CMR server further comprises:
a storage unit, adapted to store the priority policy;
an inquiry unit, adapted to respond to an inquiry request from the user, and return the priority policy to the user by the CMR user interface unit;
a setting module, adapted to respond to a setting request from the user, and store the priority policy set by the user into the storage unit; and
a presence control unit, adapted to determine the resources which need to be presented based on the priority policy, and present the resources.

3. The system according to claim 1, wherein the system further comprising:
a presence server, adapted to acquire presence information of the user, and feed back the presence information to the CMR server; and
a location server, adapted to acquire location information of the user, and feed back the location information to the CMR server.

4. The system according to claim 3, wherein the system further comprising:
a geography server, adapted to acquire a geographical longitude and latitude coordinate of the user; and
a geographical information system (GIS) Unit, adapted to convert the geographical longitude and latitude coordinate into text information of location, and thus generate the location information.

5. The system according to claim 3, wherein setting conditions of the priority policy comprise the following information: user presence information, user location information, time information, date information, and calling ID information.

6. The system according to claim 5, wherein the priority policy comprises one or multiple of the following sub-policies: user presence policy, user location policy, time policy, date policy, and calling ID policy.

7. The system according to claim 6, wherein,
the user presence policy comprises a presence condition and a presence target module, when the presence information acquired by the presence server matches the presence condition, the presence control unit presents the presence target resources corresponding to the presence target module;
the user location policy comprises a location condition and a location target module, when the location information acquired by the location server matches the location condition, the presence control unit presents the location target resources corresponding to the location target module;
the time policy comprises a time condition and a time target module, when called time information of the user matches the time condition, the presence control unit presents the time target resources corresponding to the time target module;
the date policy comprises a date condition and a date target module, when called date information of the user matches the date condition, the presence control unit presents the date target resources corresponding to the date target module; and
the calling ID policy comprises a calling ID condition and a calling ID target module, when ID information of calling the user matches the calling ID condition, the presence control unit presents the calling ID target resources corresponding to the calling ID target module.

8. The system according to claim 6, wherein each of the sub-policies is configured with priorities different from each other, and the sub-policy with highest priority among the priority policies invalidates the other sub-policies.

9. The system according to claim 8, wherein the priority is set by the user by the CMR user interface unit.

10. The system according to claim 1, wherein the CMR user interface unit is a CMR portal, wherein, the user inquires and sets the priority policy by Web/WAP.

11. The system according to claim 1, wherein the CMR user interface unit is a CMR management client, configured on the terminal of the user and used for interacting with the CMR server in the form of client to inquire and set the priority policy.

12. A method for preference processing of multimedia resources in color ring-back tone service, comprising the steps of:
acquiring related information of a user when the user is called;
determining a sub-policy with the highest priority among one or multiple sub-policies set by the user as the priority policy; and
presenting resources corresponding to the priority policy when the related information matches condition information included in the priority policy.

13. The method according to claim 12, wherein the related information comprises one or more of presence information, location information, called time information and called date information of the user and ID information of calling the user.

14. The method according to claim 13, wherein the sub-policies are respectively configured with priorities different from each other, and the sub-policy comprises one or more of the following:
user presence policy comprising presence condition, wherein when the presence information matches the presence condition, the resource corresponding to the presence condition is presented;
user location policy comprising location condition, wherein when the location information matches the location condition, the resource corresponding to the location condition is presented;
time policy, comprising time condition, wherein when the time information matches the time condition, the resource corresponding to the time condition is presented;
date policy, comprising date condition, wherein when the date information matches the date condition, the resource corresponding to the date condition is presented; and
calling ID policy, comprising calling ID condition, wherein when the ID information of calling the user matches the calling ID condition, the resource corresponding to the calling ID condition is presented.

15. The method according to claim 12, wherein the priority of the sub-policy is set by the user.

16. An apparatus for preference processing of multimedia resources in color ring-back tone service, comprising:
related information acquiring unit, adapted to acquire related information of the user when a user is called;
sub-policy determining unit, adapted to determine a sub-policy with the highest priority among the one or more sub-policies set by the user as the priority policy; and
presence unit, adapted to present resources corresponding to the priority policy when the related information matches condition information included in the priority policy.

17. The apparatus according to claim 16, wherein the related information comprises one or more of presence information, location information, called time information and called date information of the user and ID information of calling the user.

18. The apparatus according to claim 17, wherein the sub-policies are respectively configured with priorities different from each other, and the sub-policy comprises one or more of the following:
user presence policy, comprising presence condition, when the presence information matches the presence condition, the resource corresponding to the presence condition is presented;
user location policy, comprising location condition, when the location information matches the location condition, the resource corresponding to the location condition is presented;
time policy, comprising time condition, when the time information matches the time condition, the resource corresponding to the time condition is presented;
date policy, comprising date condition, when the date information matches the date condition, the resource corresponding to the date condition is presented; and
calling ID policy, comprising calling ID condition, when the ID information of calling the user matches the calling ID condition, the resource corresponding to the calling ID condition is presented.

19. The system according to claim 7, wherein each of the sub-policies is configured with priorities different from each other, and the sub-policy with highest priority among the priority policies invalidates the other sub-policies.

20. The method according to claim 13, wherein the priority of the sub-policy is set by the user.

21. The method according to claim 14, wherein the priority of the sub-policy is set by the user.
